(19) United States
(12) Patent Application Publication
(10) Pub. No.: US 2006/0233341 A1
(43) Pub. Date: Oct. 19, 2006

(54) Servicer linkage method, servicer linkage system, mediation computer and computer program product

(75) Inventors: Satoru Watanabe, Kawasaki (JP); Youji Kohda, Kawasaki (JP); Tatsuro Matsumoto, Kawasaki (JP); Yasuhide Matsumoto, Kawasaki (JP); Hideto Kihara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/191,938

(22) Filed: Jul. 29, 2005

(30) Foreign Application Priority Data
Mar. 25, 2005 (JP) 2005-089963

(51) Int. Cl. H04M 3/42

(52) U.S. Cl. 379/211.02

(57) ABSTRACT

A mediation computer accepts service linkage request condition information, which indicates a service linkage condition and requests service linkage, from a first service providing computer and accepts service linkage permission condition information, which indicates a condition for permitting service linkage, from a second service providing computer. The mediation computer generates a linkage service list, which shows a combination of services that can be linked, on the basis of the accepted service linkage request condition information and service linkage permission condition information. It becomes possible to provide a user with linkage service including a plurality of combined services by which both of the user and the servicer can request merits.

### CROSS-REFERENCE TO RELATED APPLICATIONS

This Nonprovisional application claims priority under 35 U. S.C. §119(a) on Patent Application No. 2005-89963 filed in Japan on Mar. 25, 2005, the entire contents of which are hereby incorporated by reference.

### BACKGROUND OF THE INVENTION

1. Field of the Invention

The present invention relates to a servicer linkage method with which a user who receives service provided by a plurality of servicers (service providers) which are connected via a communication network can make convenient service linkage on the basis of a service linkage condition provided by a servicer. The present invention also relates to a servicer linkage system, a mediation computer and a computer program product for realizing such a servicer linkage method.

2. Description of Related Art

With rapid progress of computer technology in recent years, it became easy to provide a user with respective services from a plurality of service providers via the Internet. When a user wants to select a plurality of services arbitrarily, the user needs to apply for use for each portal of a service providing computer which provides each service. Accordingly, in order to improve the convenience of the user, a service has started to be provided in which a broker who mediates between a service provider that provides various kinds of services and a user accepts requests for service reception from the user collectively and introduces a suitable service provider to the user.

For example, disclosed in Japanese Patent Application Laid-Open No. 2003-256685 is a volunteer activity and business activity supporting method in which a coordinator who mediates between a service provider that provides a plurality of community activity services, volunteer activity services, business activity services and the like and a user that applies for provision of service retrieves a service provider suitable for a request from the user on the basis of application information from the user and displays service providers to be selected for the user. A service thus can be realized by which all that is required to the user is to make a request only to the coordinator even when the user requests reception of a plurality of services.

Moreover, disclosed in Japanese Patent Application Laid-Open No. 2004-094508 is a service providing system which accepts a request from a user and provides combination service including combined services provided by a plurality of service systems on a network, so that the user can select service including a plurality of linked services similarly as a case of selecting one service.

The volunteer activity and business activity supporting method disclosed in Japanese Patent Application Laid-Open No. 2003-256685, however, has the following problem. That is, although it is possible to extract a plurality of services suitable for the user from a wide variety of services, the user cannot receive service including respective linked services. Therefore, there is a problem that a user needs to sign on for use for each of servicers who respectively provide the selected services, in order to receive a plurality of selected services.

Moreover, the service providing system disclosed in Japanese Patent Application Laid-Open No. 2004-094508 has the following problem. That is, although a user can receive service including a plurality of combined and linked services, the combination of services is limited to a combination which is preliminarily set by a portal provider who provides combination service. Accordingly, there is a problem that it might be impossible to find the most suitable combination of services for the user.

Furthermore, when a user receives linkage service including one service combined with another service, spoofing might be caused in which one receives only the merit of one service by pretending to have received the other service even though he has not received the other service. Especially, there is still a problem that such a risk increases, as conditions such as fare discount and privilege grant by reception of linkage service is more attractive.

### BRIEF SUMMARY OF THE INVENTION

The present invention has been made with the aim of solving the above problems, and it is an object thereof to provide a servicer linkage method capable of realizing linkage service which can provide both of the user and the servicer with merits, by automatically generating a linkage service list which shows a combination of a plurality of services. Another object of the present invention is to provide a servicer linkage system, a mediation computer and a computer program product for executing such a servicer linkage method.

Another object of the present invention is to provide a servicer linkage method capable of preventing spoofing by a malicious third person, so that only a rightful user and a rightful servicer can benefit from service linkage. Another object of the present invention is to provide a servicer linkage system, a mediation computer and a computer program product for executing such a servicer linkage method.

In order to achieve the above objects, the first aspect of the present invention is a servicer linkage method, in which a plurality of service providing computers for respectively holding information on service respectively provided by a plurality of servicers, a service request computer for accepting selection of service and requesting service, and a mediation computer capable of transmitting and receiving data to and from the plurality of service providing computers and the service request computer via a communication network are used, when the service request computer requests one service, capable of requesting reception of another service linked with the one service, characterized by comprising steps of accepting, by the mediation computer, service linkage request condition information, which indicates a service linkage condition and requests service linkage, from a first service providing computer included in the plurality of service providing computers; accepting, by the mediation computer, service linkage permission condition information, which indicates a condition for permitting service linkage, from a second service providing computer included in the plurality of service providing computers; and generating, by the mediation computer, a linkage service list, which shows a combination of services that can be linked, on the basis of the service linkage request condition information accepted from the first service providing computer and the service linkage permission condition information accepted from the second service providing computer.

Moreover, the second aspect of the present invention is a servicer linkage system, which includes: a plurality of service providing computers for respectively holding information on service respectively provided by a plurality of servicers; a service request computer for accepting selection of service and requesting service; and a mediation computer capable of transmitting and receiving data to and from the plurality of service providing computers and the service request computer via a communication network; and which, when the service request computer requests one service, can request reception of another service linked with the one service, characterized in that the mediation computer comprises: means for accepting service linkage request condition information, which indicates a service linkage condition and requests service linkage, from a first service providing computer included in the plurality of service providing computers; means for accepting service linkage permission condition information, which indicates a condition for permitting service linkage, from a second service providing computer included in the plurality of service providing computers; and linkage service list generating means for generating a linkage service list, which shows a combination of services that can be linked, on the basis of the service linkage request condition information accepted from the first service providing computer and the service linkage permission condition information accepted from the second service providing computer.

Moreover, the third aspect of the present invention is the servicer linkage system according to the second aspect, characterized in the mediation computer further comprises: storage means for storing a service list which shows service respectively provided by the plurality of service providing computers; first service extracting means for extracting a service, which meets a linkage partner condition indicated by the service linkage request condition information accepted from the first service providing computer, from the service list as a first service; and second service extracting means for extracting a service, which meets a condition for permitting linkage indicated by the service linkage permission condition information accepted from the second service providing computer, from the service list as a second service; wherein the linkage service list generating means generates the linkage service list on the basis of meeting status between a service provided by the first service providing computer and the second service and meeting status between a service provided by the second service providing computer and the first service.

Moreover, the fourth aspect of the present invention is the servicer linkage system according to the third aspect, characterized in that the mediation computer further comprises: service identifying information accepting means for accepting service identifying information, which identifies a service selected by the service request computer, from the service request computer; linkage service extracting means for extracting a service, which can be linked with the service identified by the service identifying information accepted by the service identifying information accepting means, from the linkage service list; and means for linking the service identified by the service identifying information accepted from the service request computer and the service extracted from the service list.

Moreover, the fifth aspect of the present invention is the servicer linkage system according to the fourth aspect, characterized in that the mediation computer further comprises means for transmitting information, which indicates acceptance of a provision request of one service from the service request computer, to a service providing computer, which provides the one service, included in the plurality of service providing computers; the plurality of service providing computers respectively comprise means for generating certification information, which certificates provision of the one service, and transmitting the certification information to the mediation computer when receiving information, which indicates acceptance of the provision request of the one service from the service request computer, from the mediation computer; and the mediation computer receives the certification information from a service providing computer which transmitted the certification information and transmits the received certification information to a service providing computer which provides the another service.

Moreover, the sixth aspect of the present invention is a mediation computer, which can transmit and receive data to and from a plurality of service providing computers that provide service and a service request computer that selects service to be provided and receives provision via a communication network and links one service with another service provided by the service providing computers, characterized by comprising: means for accepting service linkage request condition information, which indicates a service linkage condition and requests service linkage, from a first service providing computer included in the plurality of service providing computers; means for accepting service linkage permission condition information, which indicates a condition for permitting service linkage, from a second service providing computer included in the plurality of service providing computers; and means for generating a linkage service list, which shows a combination of services that can be linked, on the basis of the service linkage request condition information accepted from the first service providing computer and the service linkage permission condition information accepted from the second service providing computer.

Moreover, the seventh aspect of the present invention is a computer program product for controlling a computer, which can transmit and receive data to and from a plurality of service providing computers that provide service and a service request computer that selects service to be provided and receives provision via a communication network, and can links one service with another service provided by the service providing computers, characterized in that the computer program product comprises: a computer readable storage medium having computer readable program code means embodied in the medium, the computer readable program code means comprising computer instruction means for: accepting service linkage request condition information, which indicates a service linkage condition and requests service linkage, from a first service providing computer; accepting service linkage permission condition information, which indicates a condition for permitting service linkage, from a second service providing computer; and generating a linkage service list, which shows a combination of services that can be linked, on the basis of the service linkage request condition information and the service linkage permission condition information.

In the first, second, third, sixth and seventh aspects of the present invention described above, a plurality of service providing computers respectively corresponding to a plurality of servicers that provide one or a plurality of services, a service request computer for accepting selection of service and requesting service and a mediation computer which functions as a relay between the service providing computers and the service request computer are used. The mediation computer accepts service linkage request condition information, which indicates a service linkage condition and requests service linkage, from the first service providing computer, accepts service linkage permission condition information, which indicates a condition for permitting service linkage, from the second service providing computer and generates a linkage service list, which shows a combination of services that can be linked, on the basis of these service linkage request condition information and service linkage permission condition information.

With the first, second, third, sixth and seventh aspects of the present invention constructed as mentioned above, since a linkage service list is generated on the basis of the service linkage request condition information and the service linkage permission condition information to generate a plurality of combinations of services automatically, a portal provider does not need to consider a combination of linkage service. Moreover, since linkage service of a wide variety of combinations is generated, the convenience in use of a plurality of services is enhanced and the range of choices is expanded for a user who desires to receive linkage service. Furthermore, since each servicer can specify a condition such as a linkage partner as a condition relating to linkage and expand opportunities to provide service, it is possible to create a new opportunity for business dealings.

Moreover, in the fourth aspect of the present invention, the mediation computer accepts service identifying information, which indicates a service selected by the service request computer, from the service request computer. The mediation computer then extracts a service, which can be linked with the service indicated by the accepted service identifying information, from the linkage service list and links the accepted service with the service extracted from the service list.

With the fourth aspect of the present invention constructed as mentioned above, since service linkage is made automatically when the user only selects service, the user can use linkage service generated by the mediation computer without the need to be conscious of the existence of other service. Accordingly, the user can select a convenient servicer without being limited to a certain servicer.

Furthermore, in the fifth aspect of the present invention, the mediation computer transmits information, which indicates acceptance of a provision request of one service from the service request computer, to a service providing computer which provides said one service. The service providing computer then generates certification information, which certificates provision of said one service for the received information, and transmits the certification information to the mediation computer. Furthermore, the mediation computer transmits the received certification information to a service providing computer which provides another service.

With the fifth aspect of the present invention constructed as mentioned above, a servicer who provides another service that is a linkage partner can confirm that the service linkage is one made by a user who has been certificated by a rightful servicer to have requested reception of service. Accordingly, it is possible to prevent unauthorized use such as spoofing by a malicious third person and it becomes possible to make dynamic service linkage while maintaining the confidence between linked servicers.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic block diagram showing an example of the configuration of a servicer linkage system of the present invention;

FIG. 2 is a block diagram showing an example of the internal configuration of a mediation computer which composes a servicer linkage system of the present invention;

FIG. 3A and FIG. 3B are schematic views showing an example of the data structure of a service list which is stored in a storage device of a mediation computer that composes a servicer linkage system of the present invention;

FIG. 4A and FIG. 4B are schematic views showing an example of the data structure of service linkage request condition information which is stored in a storage device of a mediation computer that composes a servicer linkage system of the present invention;

FIG. 5A and FIG. 5B are schematic views showing an example of the data structure of service linkage permission condition information which is stored in a storage device of a mediation computer that composes a servicer linkage system of the present invention;

FIG. 6A, FIG. 6B and FIG. 6C are schematic views showing an example of the data structure of a linkage service list which is stored in a storage device of a mediation computer that composes a servicer linkage system of the present invention;

FIG. 7 is a flow chart showing the procedure of a linkage service list generating process of a mediation computer which is used in a servicer linkage system of the present invention;

FIG. 8A and FIG. 8B are views illustrating events used in a servicer linkage system of the present invention;

FIG. 9 is a flow chart showing the procedure of a linkage service starting process of a mediation computer which is used in a servicer linkage system of the present invention; and

FIG. 10 is a flow chart showing the procedure of a certification information issuing process of a mediation computer and a service providing computer which are used in a servicer linkage system of the present invention.

### DETAILED DESCRIPTION OF THE PRESENT INVENTION

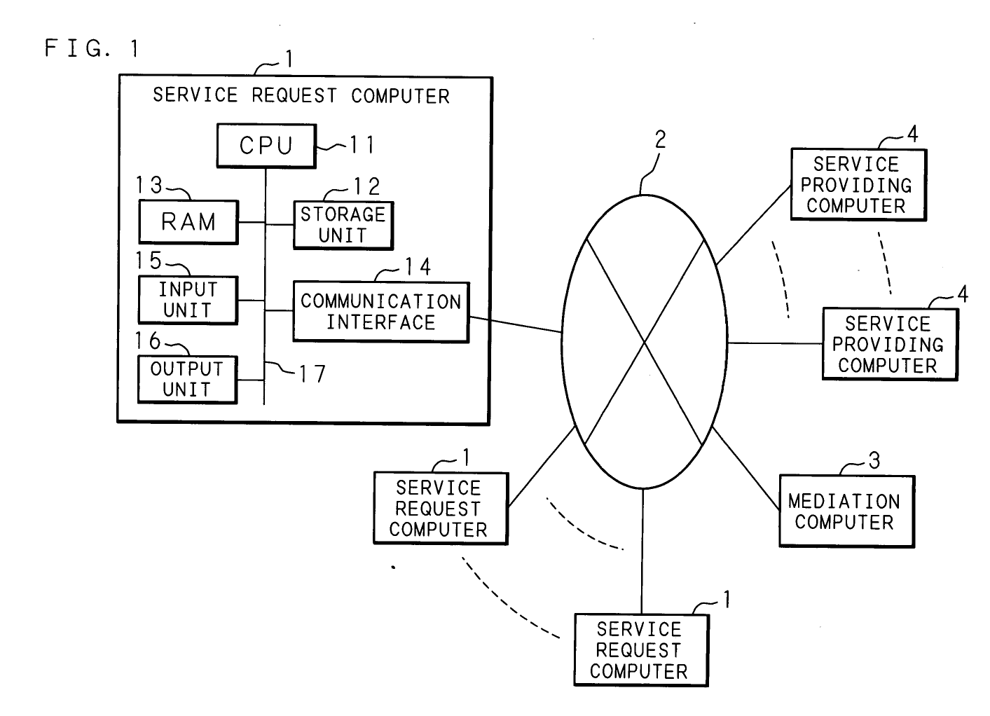

The following description will explain the present invention in the concrete with reference to the drawings illustrating some preferred embodiments thereof. FIG. 1 is a schematic block diagram showing an example of the configuration of a servicer linkage system of the present invention.

In the system of the present invention, a plurality of service request computers 1, 1, . . . , a mediation computer 3 and service providing computers 4, 4, . . . which are used by service providers for respectively providing different kind services or same kind services are connected via the Internet 2, which functions as a communication network, so as to transmit and receive data to and from each other.

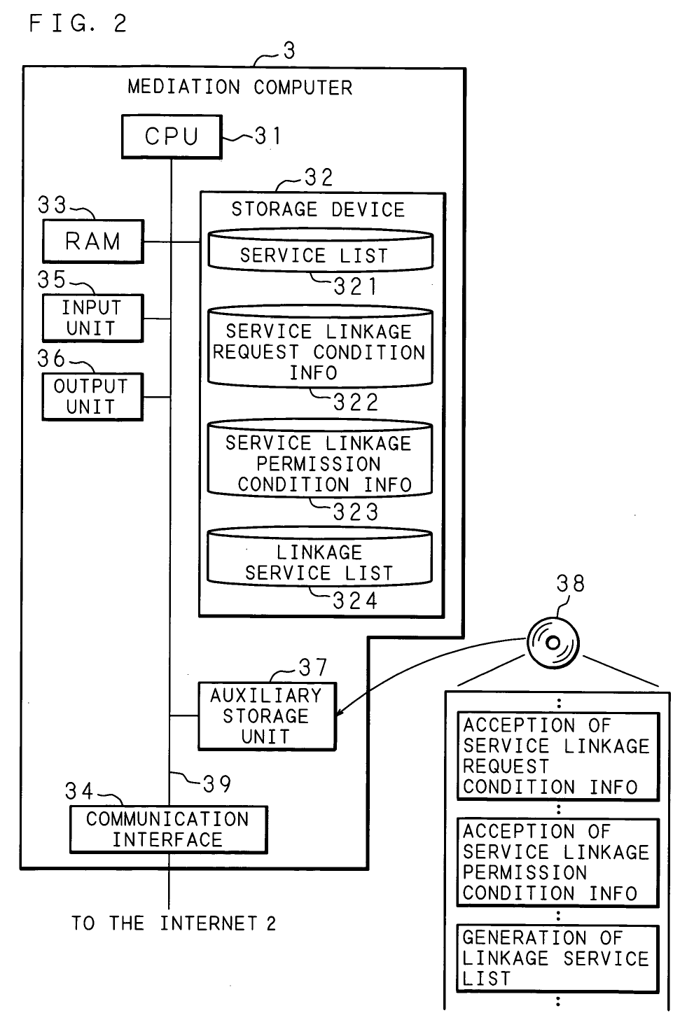

FIG. 2 is a block diagram showing an example of the internal configuration of the mediation computer 3 which composes a servicer linkage system of the present invention. The mediation computer 3 at least comprises a CPU (central processing unit) 31, a storage device 32, a RAM 33, a communication interface 34 to be connected with an external communication network such as the Internet 2, an input unit 35, an output unit 36 and an auxiliary storage unit 37 constituted of a portable recording medium 38 such as a DVD or a CD-ROM.

The CPU 31 is connected with each hardware unit mentioned above of the mediation computer 3 via an internal bus 39. The CPU 31 executes various kinds of software functions while controlling each hardware unit mentioned above according to a processing program stored in the storage device 32, e.g. a program for identifying linkage service provided by the service providing computers 4, 4, . . . or the like.

The storage device 32 incorporates a fixed storage device (hard disk), a ROM and the like and stores a processing program necessary for realizing a function as the mediation computer 3, which is obtained from an external computer via the communication interface 34 or from the portable recording medium 38 such as a DVD or a CD-ROM. In addition to the above processing program, the storage device 32 also stores various kinds of information such as a service list 321 which shows the content of service provided by the service providing computers 4, 4, . . . , service linkage request condition information 322 which indicates a service linkage condition and requests service linkage, service linkage permission condition information 323 which indicates a condition for permitting service linkage and a linkage service list 324 which shows the content of linked service.

The RAM 33 is constituted of a DRAM or the like and stores temporary data which is generated in execution of software by the CPU 31. The communication interface 34 is connected so as to communicate with an external communication network such as the Internet 2, and transmits and receives data necessary for processes of the mediation computer 3.

The input unit 35 is a pointing device such as a mouse for selecting a word displayed on a screen of the output unit 36 which is a display device such as a liquid crystal display (LCD) or a display (CRT) for displaying and outputting image, a keyboard for inputting text data by key entry on the screen, or the like.

The auxiliary storage unit 37 is a drive device of the portable recording medium 38 such as a CD-ROM or a DVD and downloads a program, data and the like to be processed by the CPU 31 into the storage device 32. Moreover, a backup can be made when data processed by the CPU 31 is written in this auxiliary storage unit 37.

The following description will explain the configuration of the plurality of service request computers 1, 1, . . . which compose the system of this embodiment. As shown in FIG. 1, each service request computer 1 at least comprises a CPU (central processing unit) 11, a storage unit 12, a RAM 13, a communication interface 14 to be connected with an external communication network such as the Internet 2, an input unit 15 and an output unit 16.

The CPU 11 is connected with each hardware unit mentioned above of the service request computer 1 via an internal bus 17 and executes various kinds of software functions while controlling each hardware unit mentioned above according to a program stored in the storage unit 12, e.g. a web browser for executing a plurality of services provided by the service providing computers 4, 4, . . . or the like.

The storage unit 12 incorporates a fixed storage device (hard disk), a ROM and the like and stores a program such as a browser necessary for realizing a function as the service request computer 1. The RAM 13 is constituted of a DRAM or the like and stores temporary data which is generated in execution of software by the CPU 11. The communication interface 14 is connected so as to communicate with the Internet 2 or the like, and transmits and receives data necessary for processes of the service request computer 1.

The input unit 15 is a pointing device such as a mouse for selecting a word displayed on a screen of the output unit 16 which is a display device such as a liquid crystal display (LCD) or a display (CRT) for displaying and outputting image, a keyboard for inputting text data by key entry on the screen, or the like.

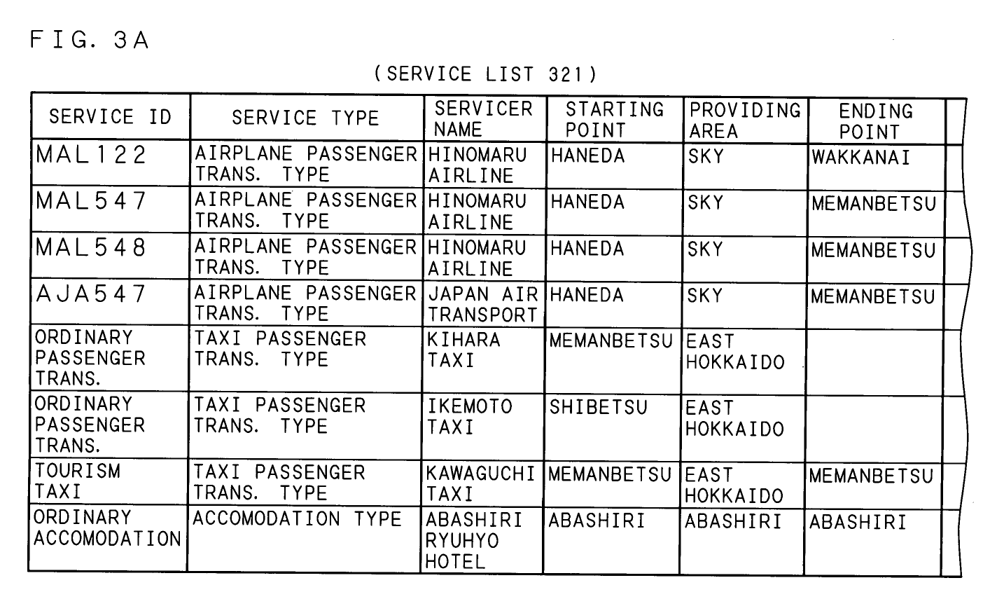

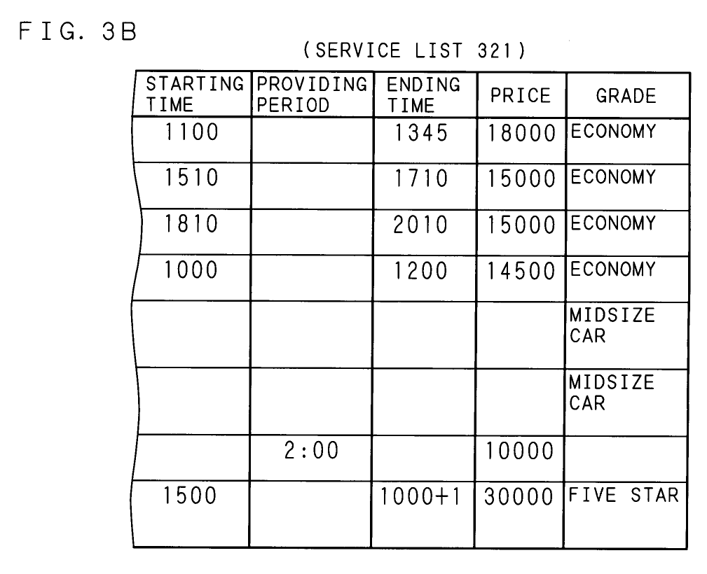

FIG. 3A and FIG. 3B are schematic views showing an example of the data structure of the service list 321 which is stored in the storage device 32 of the mediation computer 3 that composes a servicer linkage system of the present invention. The service list 321 shows the content of service provided by servicers, which is collected-from the service providing computers 4, 4, . . . . In particular, the service list 321 is stored as a table including data respectively at each item shown as a record which relates a service ID for identifying service, a service type, a servicer name, a starting point of service, a providing area of service and an ending point of service, starting time of service, providing period of service and ending time of service, price and grade. It should be noted that the storage format of the service list 321 is not limited to the table format shown in FIG. 3A and FIG. 3B and may be storage format described in a format such as an HTML or an XML using a tag.

Moreover, the mediation computer 3 stores various kinds of lists such as a business category list which shows the category of business of a servicer, a servicer list which shows the name of a servicer related to the category of business, a service type list which shows the service type related to the category of business and, furthermore, a service attribute list which shows attribute information such as the area where service is provided, the time when service is provided and the grade as basic information which forms the service list 321, although they are not shown in the figure. The service list 321 is formed based on basic information read from these lists.

The service ID which is an item of the service list 321 is information for identifying service. In the example shown in FIG. 3A and FIG. 3B, as the service ID are information such as “MAL 122” or “AJA 547” for indicating the flight number, information such as ordinary passenger transportation” or “tourism taxi” for indicating the form of service and information such as “family pack” or “weekday discount” for indicating the name of service. The service type which is another item of the service list 321 is information such as “airplane passenger transportation type”, “taxi passenger transportation type” or “accommodation type” for indicating the type of service. The servicer name which is another item of the service list 321 is information such as “Hinomaru Airline”, “Kihara Taxi” or “Abashiri Ryuhyo Hotel” for indicating the name of a servicer.

The starting point, the providing area and the ending point which are other items of the service list 321 are information for indicating a point where service starts, an area where service is provided and a point where service ends. For example, regarding service relating to an airplane passenger transportation type, a point where service starts is “Haneda”, an area where service is provided is “sky” and a point where service ends is “Wakkanai”.

The starting time, the providing period and the ending time which are other items of the service list 321 are information for indicating time when service starts, amount of time service is provided and time when service ends.

The price which is another item of the service list 321 is information for indicating the price to be paid for service. The grade which is another item of the service list 321 is, for example, information for indicating the grade of a seat such as “economy” for service relating to the airplane passenger transportation type or information for indicating the grade of a vehicle such as “midsize car” for service relating to the taxi passenger transportation type.

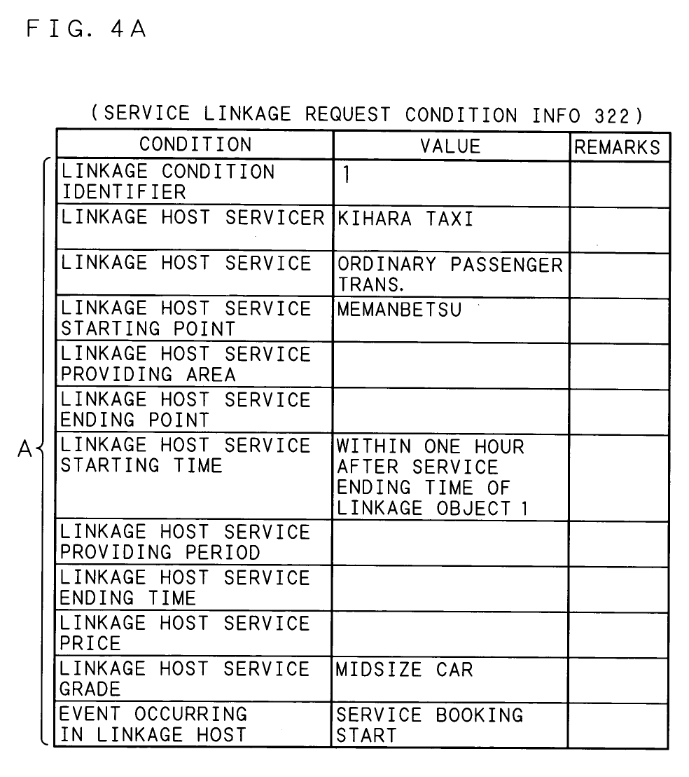

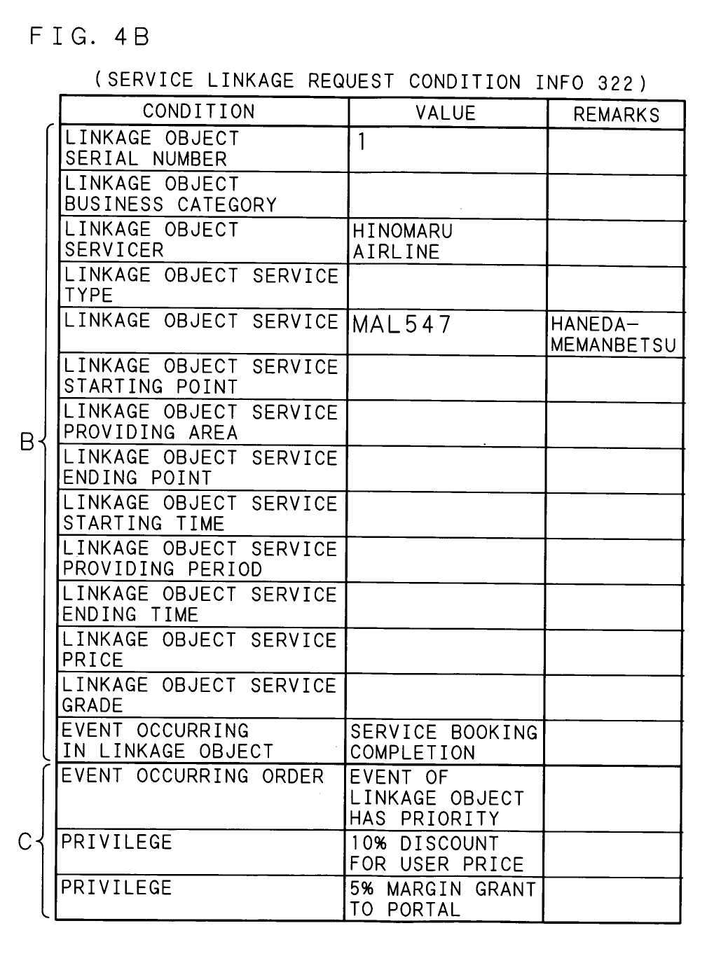

FIG. 4A and FIG. 4B are schematic views showing an example of the data structure of the service linkage request condition information 322 which is stored in the storage device 32 of the mediation computer 3 that composes a servicer linkage system of the present invention. The service linkage request condition information 322 is information, which indicates a condition of a service linkage partner, obtained from a service providing computer 4 managed by a servicer. In the service linkage request condition information 322 shown in FIG. 4A and FIG. 4B, a group shown as “A” are items relating to a linkage requester. Included as the content of these items are a linkage condition identifier, a linkage host servicer, a linkage host service, a linkage host service starting point, a linkage host service providing area, a linkage host service ending point, linkage host service starting time, linkage host service providing period, linkage host service ending time, linkage host service price, linkage host service grade, an event occurring in the linkage host and the like. It should be noted that all of these items do not always have to have data.

In the service linkage request condition information 322 shown in FIG. 4A and FIG. 4B, a group shown as “B” are items relating to a linkage request destination. Included as the content of these items are a linkage object serial number, a linkage object business category, a linkage object servicer, a linkage object service type, a linkage object service, a linkage object service starting point, a linkage object service providing area, a linkage object service ending point, linkage object service starting time, linkage object service providing period, linkage object service ending time, linkage object service price, linkage object service grade, an event occurring in the linkage object and the like. It should be noted that, since data shown in these items is a condition for requesting linkage, all of the items do not always have to have data and the condition can be deemed to be eased as a smaller number of data is shown.

In the service linkage request condition information 322 shown in FIG. 4A and FIG. 4B, a groups shown as “C” are items relating to service linkage. Included as the content of these items are an event occurring order, privilege and the like.

The following description will explain the content of the service linkage request condition information 322 shown in FIG. 4A and FIG. 4B. This service linkage request condition information 322 is a request from a servicer “Kihara Taxi”, which requests linkage, and includes “Hinomaru Airline” and “MAL 547” shown as conditions. That is, linkage with service of a flight “MAL 547” of a servicer “Hinomaru Airline” is being requested. It is shown as the event occurring order that “an event of linkage object has priority” when linkage service due to this request is provided. Accordingly, an event of the linkage object is completed by occurring of an event “service booking completion” of the linkage object which is the request destination, linkage service is completed by occurring of an event “service booking start” of the linkage host which is the requester and privilege of “10% discount for user price” and “5% margin grant to a portal” are granted to a user who receives service. It should be noted that the concrete content of linkage service is to provide price discount service in transfer by “midsize car” for a passenger of a flight “MAL 547” of “Hinomaru Airline” , which arrives at Memanbetsu Airport.

It should be noted that various kinds of conditions can be defined by changing the group shown as the “B”. For example, by changing the linkage object service into “MAL 547 or MAL 548”, linkage is requested for “MAL 548” in addition to “MAL 547”. For another example, by taking out the specification of the linkage object servicer and the linkage object service and changing the linkage object service ending point to “Memanbetsu Airport”, linkage is requested for all services of all servicers, which arrive at the Memanbetsu Airport. For another example, by setting a plurality of services as linkage object, it is also possible to link three or more services. For example, linkage to service of “airplane passenger transportation type” and “accommodation type” shown in FIG. 4A and FIG. 4B may be requested in order to receive linkage service for delivering a user, who was on an airplane which has been arrived, to his accommodation facility by taxi.

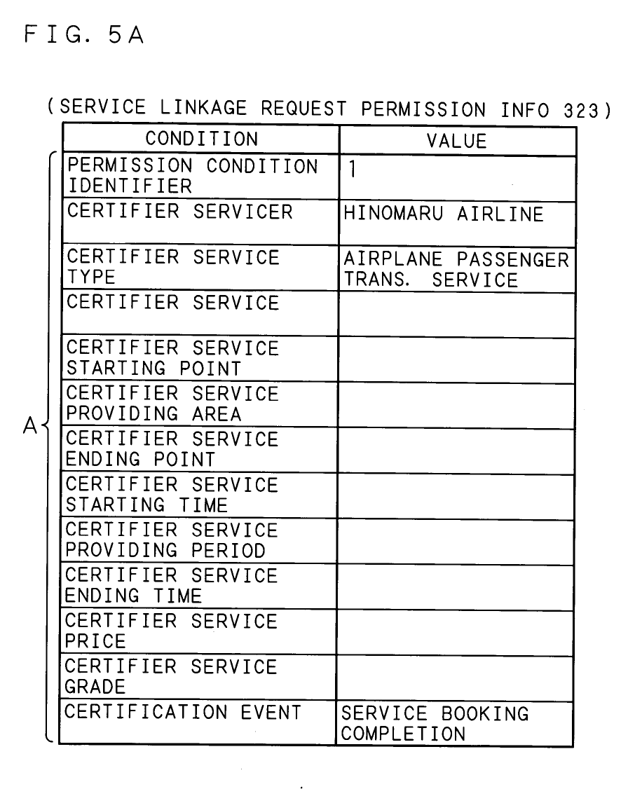

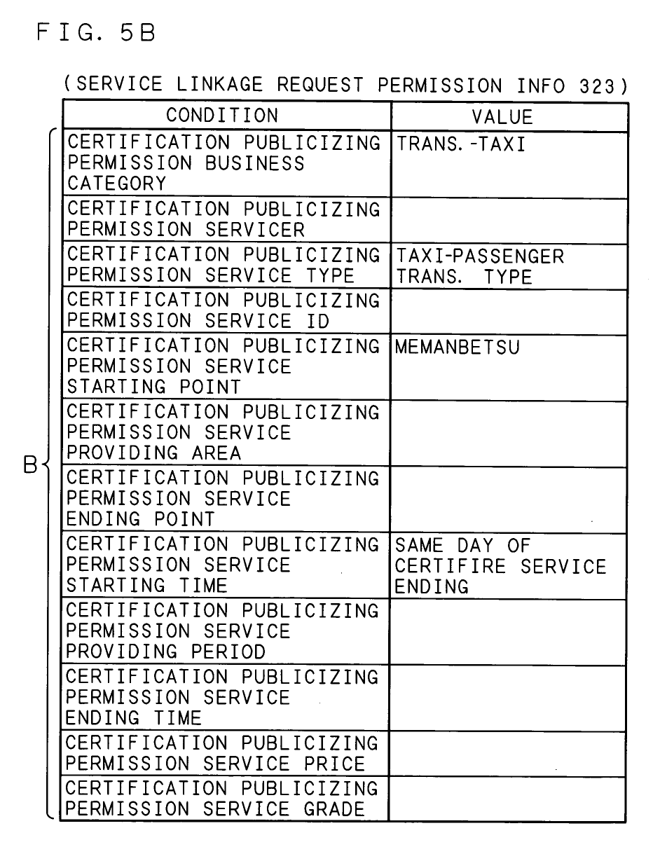

FIG. 5A and FIG. 5B are schematic views showing an example of the data structure of the service linkage permission condition information 323 which is stored in the storage device 32 of the mediation computer 3 that composes a servicer linkage system of the present invention. The service linkage permission condition information 323 is information, which indicates a condition for permitting service linkage, obtained from a service providing computer 4 managed by a servicer. In the service linkage permission condition information 323 shown in FIG. 5A and FIG. 5B, the group shown as “A” are items relating to a request object which is a request destination of linkage, i.e. linkage permitter. Included as the content of these items are a permission condition identifier, a certifier servicer, a certifier service type, a certifier service, a certifier service starting point, a certifier service providing area, a certifier service ending point, certifier service starting time, certifier service providing period, certifier service ending time, certifier service price, certifier service grade, a certification event and the like. It should be noted that all of these items do not always have to have data. As shown in FIG. 5A and FIG. 5B, a service of a linkage permitter whom linkage is requested is represented as a certifier in the service linkage permission condition information 323. This is because certification information which certificates provision of service is issued when linkage for a linkage request is permitted, linkage service is established and a service for which such linkage has been permitted is provided to a user.

In the service linkage permission condition information 323 shown in FIG. 5A and FIG. 5B, the group shown as “B” are items relating to a linkage requester, i.e. linkage permission destination. Included as the content of these items are a certification publicizing permission business category, a certification publicizing permission servicer, a certification publicizing permission service type, a certification publicizing permission service ID, a certification publicizing permission service starting point, a certification publicizing permission service providing area, a certification publicizing permission service ending point, certification publicizing permission service starting time, certification publicizing permission service providing period, certification publicizing permission service ending time, certification publicizing permission service price, certification publicizing permission service grade and the like. It should be noted that, since data shown in these items is a condition for permitting linkage, all of the items do not always have to have data and the condition can be deemed to be eased as a smaller number of data is shown. As shown in FIG. 5A and FIG. 5B, service of a linkage requester is represented as certification publicizing permission in the service linkage permission condition information 323. This is because publicizing of certification information which certificates provision of service is permitted when linkage is permitted and service for which such linkage has been permitted is provided.

The service linkage permission condition information 323 shown in FIG. 5A and FIG. 5B indicates that linkage is permitted for a service linkage request which satisfies the conditions shown in the group of the “B”. In the example shown in FIG. 5A and FIG. 5B, the category of business is “transportation-taxi”, the service type is “taxi passenger transportation type”, the service starting point is “Memanbetsu Airport” and service which starts on the same day as the service ending of a certifier becomes service for which linkage is permitted. It should be noted that various kinds of conditions can be defined by changing the group shown as the “B”. For example, by changing the service type into “taxi passenger transportation type or taxi passenger tourism type”, linkage with service of “taxi passenger tourism type” can be also permitted.

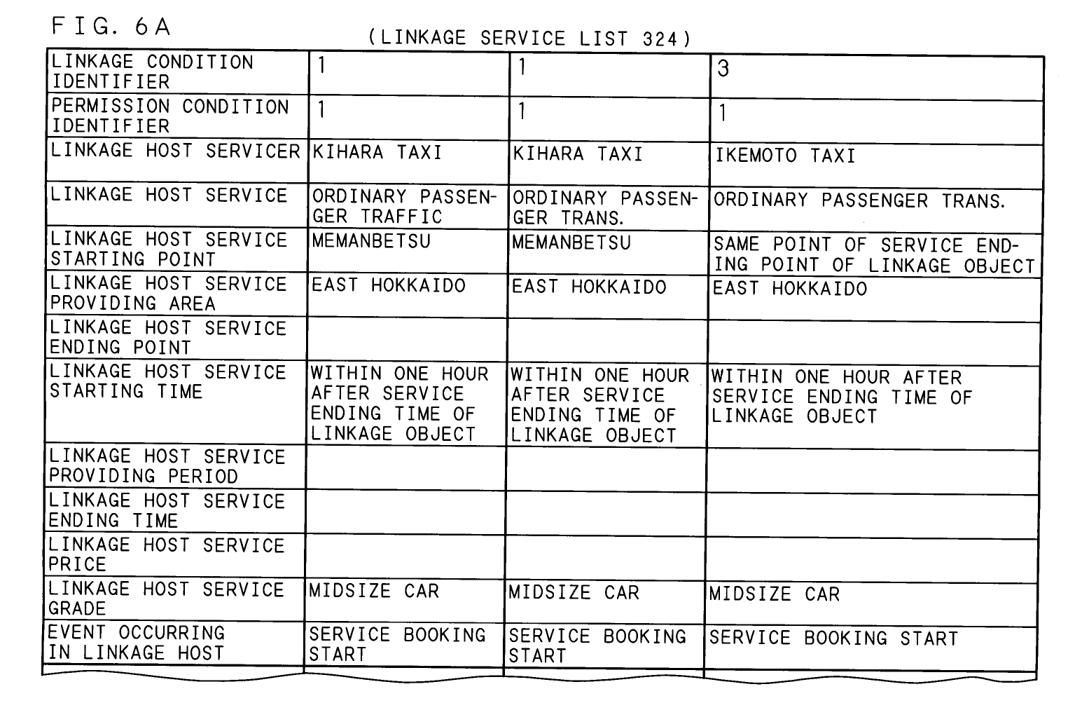

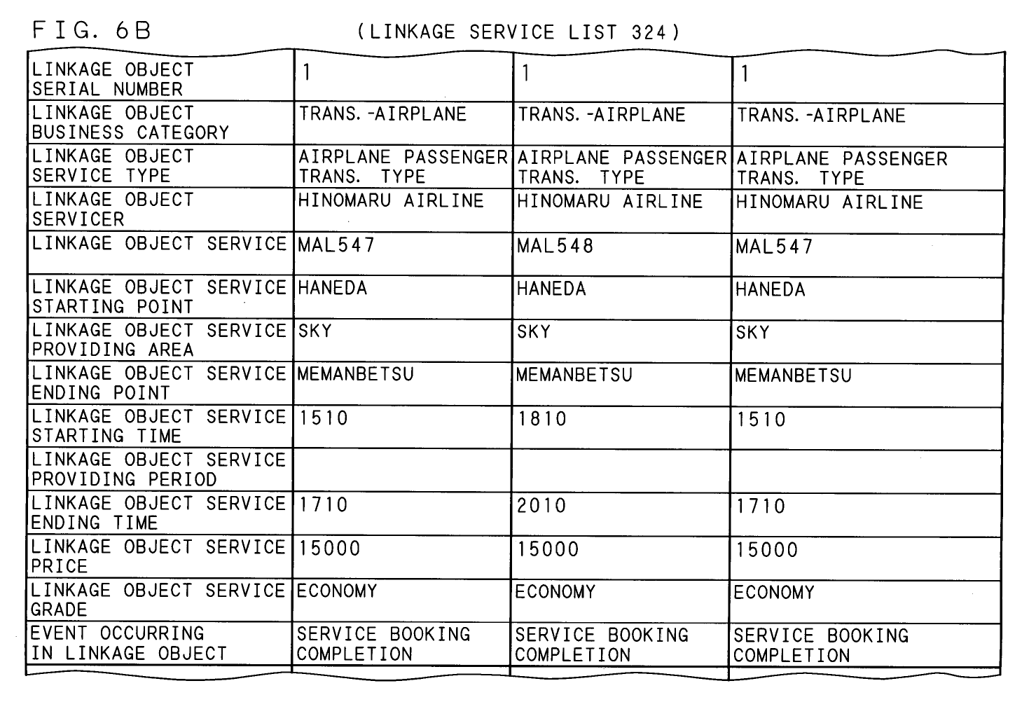

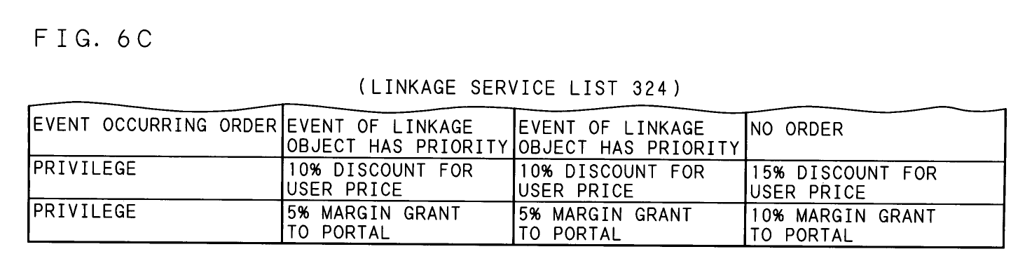

FIG. 6A, FIG. 6B and FIG. 6C are schematic views showing an example of the data structure of the linkage service list 324 which is stored in the storage device 32 of the mediation computer 3 that composes a servicer linkage system of the present invention, showing originally one view in a divided manner. The linkage service list 324 is a list of service that can be linked, which is generated when it is judged that service that can be linked exists on the basis of the service linkage request condition information and the service linkage permission condition information. Shown in the linkage service list 324 as the content relating to linkage service which is a combination of services that can be linked are a linkage condition identifier, a permission condition identifier, a linkage host servicer, a linkage host service, a linkage host service starting point, a linkage host service providing area, a linkage host service ending point, linkage host service starting time, linkage host service providing period, linkage host service ending time, linkage host service price, linkage host service grade, an event occurring in the linkage host, a linkage object serial number, a linkage object business category, a linkage object service type, a linkage object servicer, a linkage object service, a linkage object service starting point, a linkage object service providing area, a linkage object service ending point, linkage object service starting time, linkage object service providing period, linkage object service ending time, linkage object service price, linkage object service grade, an event occurring in the linkage object, an event occurring order and privilege. It should be noted that the storage format of this linkage service list 324 is not limited to the table format shown in FIG. 6A, FIG. 6B and FIG. 6C and may be described in a format such as an HTML or an XML using a tag.

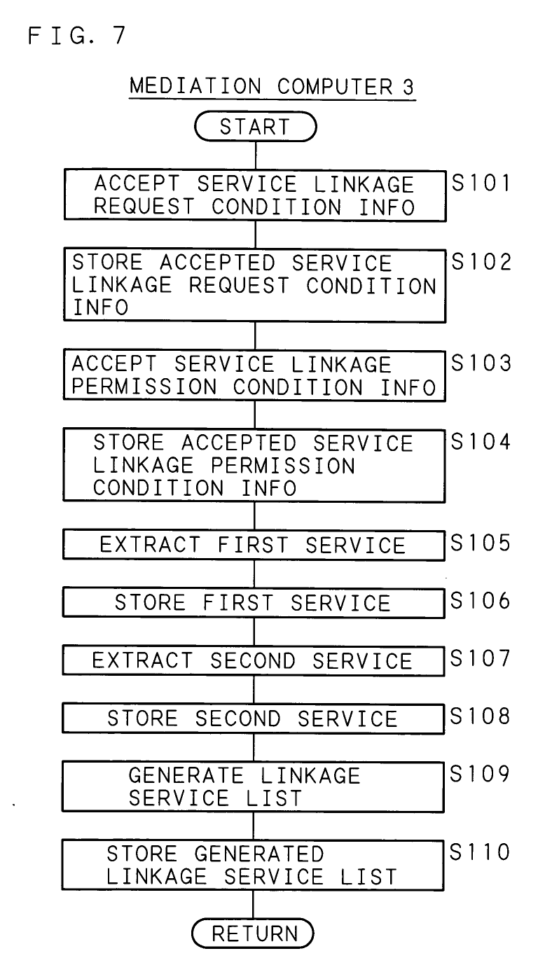

The following description will explain processes of the respective kinds of devices which are used in a servicer linkage system of the present invention. FIG. 7 is a flow chart showing the procedure of a linkage service list generating process of the mediation computer 3 which is used in a servicer linkage system of the present invention. Each of the service providing computers 4, 4, . . . stores service linkage request condition information 322 and/or service linkage permission condition information 323 registered by a servicer and respectively transmits service linkage request condition information 322 and/or service linkage permission condition information 323 to the mediation computer 3 automatically or in response to an access from the mediation computer 3.

The CPU 31 of the mediation computer 3 accepts service linkage request condition information 322 from each of the service providing computers 4,4, . . . by the communication interface 34 (S101), and stores the accepted service linkage request condition information 322 in the storage device 32 (S102). The CPU 31 of the mediation computer 3 further accepts service linkage permission condition information 323 from each of the service providing computers 4, 4, . . . by the communication interface 34 (S103), and stores the accepted service linkage permission condition information 323 in the storage device 32 (S104).

The CPU 31 of the mediation computer 3 extracts a service, which meets a condition of a linkage partner indicated by the service linkage request condition information 322, from the service list 321 as a first service (S105), and stores the extracted first service in the storage device 32 (S106). The CPU 31 of the mediation computer 3 further extracts a service, which meets a condition for permitting linkage indicated by the service linkage permission condition information 323, from the service list 321 as a second service (S107), and stores the extracted second service in the storage device 32 (S108).

The CPU 31 of the mediation computer 3 then generates a linkage service list 324 on the basis of the meeting status between a service of a requester of the service linkage request condition information 322 and the second service and the meeting status between a service of a permitter of the service linkage permission condition information 323 and the first service (S109), and stores the generated linkage service list 324 in the storage device 32 (S110). That is, a combination of services, which meet a condition indicated by the service linkage request condition information 233 and a condition indicated by the service linkage permission condition information 323, is extracted and stored in the storage device 32.

The linkage service list 324 is generated and stored in the storage device 32 in a process described above. It should be noted that the process is not limited to the above one as long as a combination of services, which meet a condition indicated by the service linkage request condition information 322 and a condition indicated by the service linkage permission condition information 323, is extracted and stored in the storage device 32, and various kinds of processes can be applied.

It should be noted that data which respectively compose the service linkage request condition and the service linkage permission condition needs to be standardized in service linkage. For example, when the content of data used as “event”, “industry category”, “service type”, “starting point” and “ending point” is not standardized between a linkage host servicer and a certifier servicer, linkage might not be established even when both planned to indicate the same object. Accordingly, each servicer needs to perform a process such as referring to a common data list in setting of a condition, by preliminarily performing processes such as preparing a common data list, distributing the common data list to each servicer and registering the common data list as a dictionary to the mediation computer 3.

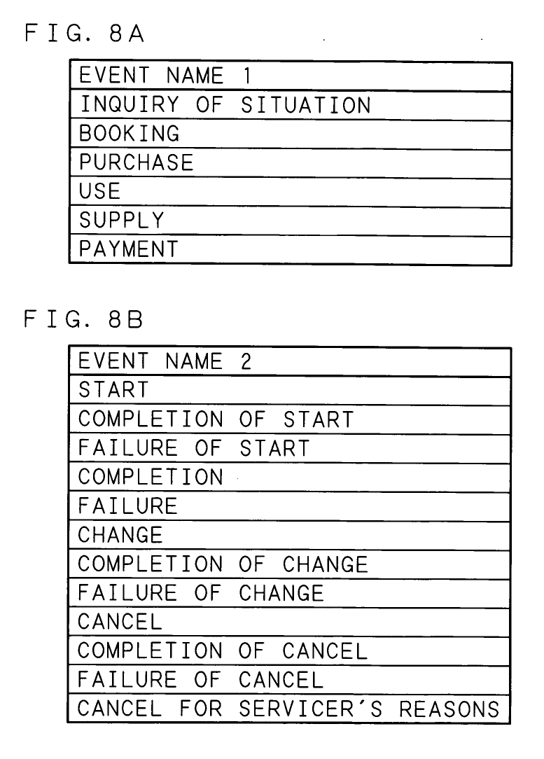

Moreover, for deciding timing of execution of the event, i.e. service, mentioned above that can be linked, data indicating timing of service execution also needs to be standardized. FIG. 8A and FIG. 8B are views illustrating events used in a servicer linkage system of the present invention. FIG. 8A and FIG. 8B show lists of events to be set for standardizing timing for executing service. An event for specifying timing of service execution can be defined by combining the respective events shown in FIG. 8A and FIG. 8B. Accordingly, linkage service can be proposed and executed at appropriate timing by linking service on the basis of events defined in combination.

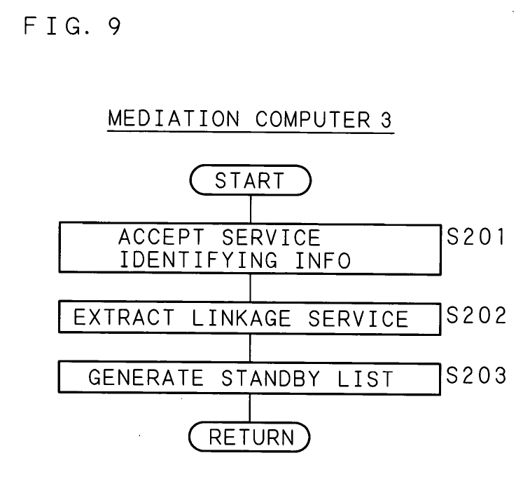

FIG. 9 is a flow chart showing the procedure of a linkage service starting process of the mediation computer 3 which is used in a servicer linkage system of the present invention. A user who desires to receive service operates the service request computer 1 to access the mediation computer 3 and receives presentation of service which can be linked on the basis of the linkage service list 324 from the mediation computer 3. The user then operates the service request computer 1 for selecting service which the user desires to receive from a plurality of represented services that can be provided using the service providing computers 4, 4, . . . . Receiving the operation, the service request computer 1 transmits service identifying information which identifies the selected service to the mediation computer 3. The mediation computer 3 receives the service identifying information as information for indicating acceptance of a service provision request from the service request computer 1.

The CPU 31 of the mediation computer 3 accepts the service identifying information from the communication interface 34 (S201), extracts linkage service that can be completed by linkage with service indicated by the accepted service identifying information, i.e. linkage service which is completed by combining one service indicated by the service identifying information with another service, from the linkage service list 324 (S202), and generates a standby list for waiting for reception of service identifying information for indicating requesting of reception of another service relating to the extracted linkage service (S203).

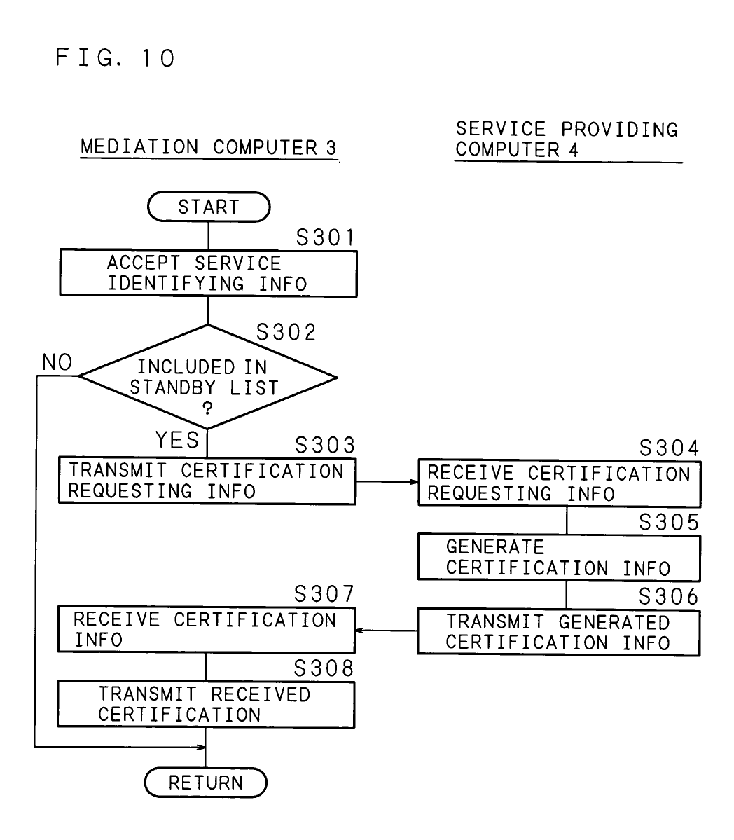

FIG. 10 is a flow chart showing the procedure of a certification information issuing process of the mediation computer 3 and the service providing computer 4 which are used in a servicer linkage system of the present invention. When a user requests one service (which will be hereinafter referred to as a first service) in a linkage service starting process of the flow chart shown in FIG. 9 and desires to receive another service (which will be hereinafter referred to as a second service) which can be linked with the first service, the user operates the service request computer 1 to access the mediation computer 3 and operates the service request computer 1 to specify the second service which user desires to receive. Accepting the operation, the service request computer 1 transmits service identifying information for indicating the specified second service to the mediation computer 3. The mediation computer 3 receives the service identifying information as information for indicating acceptance of a service provision request from the service request computer 1.

The CPU 31 of the mediation computer 3 accepts service identifying information from the communication interface 34 (S301), and judges whether the accepted service identifying information and linkage service corresponding to a service request computer 1 which is a sender thereof are included in the standby list or not (S302).

When it is judged in the step S302 that the linkage service corresponding to the accepted service identifying information is included in the standby list (S302: YES), the CPU 31 of the mediation computer 3 transmits certification requesting information, which requests issuance of certification information that certificates provision of the first service, to a service providing computer 4 (which will be hereinafter referred to as a first service providing computer 4) of a servicer who provides the first service (S303).

The first service providing computer 4 receives the certification requesting information (S304), and judges whether the first service providing computer 4 itself provides or not the first service corresponding to the requested certification. When it is judged that the first service is being provided, the first service providing computer 4 generates certification information for indicating provision of the first service (S305), and transmits the generated certification information to the mediation computer 3 (S306). Whether the first service is being provided or not is judged based on whether the user has done an event relating to the first service, e.g. “service booking completion”, or not. It should be noted that generation and transmission of certification information are not performed when the first service providing computer 4 judged that the first service is not being provided.

The CPU 31 of the mediation computer 3 receives the certification information (S307), and transmits the received certification information to a service providing computer 4 (which will be hereinafter referred to as a second service providing computer 4) of a servicer who provides the second service (S308). The second service providing computer 4, which can judge from the received certification information that the user desires to receive the first service, provides the second service and completes linkage service, so that privilege relating to the linkage service, e.g. price discount, can be executed.

When it is judged in the step S302 that the linkage service corresponding to the received service identifying information is not included in the standby list (S302: NO), the processes after the step S303 are not performed. It should be noted that, in this case, even the service identifying information which is not included in the standby list is regarded as service identifying information which is first selected in the linkage service starting process and the linkage service starting process is executed even though the processes after the step S303 are not executed as a certification information issuing process.

With such a process, when a user requests reception of one service and further requests reception of linkage service, it is judged whether the further request is a request by a rightful user or not on the basis of existence of certification information generated by a servicer who provides said one service. The user can receive the linkage service only when it is judged that the request is from a rightful user. Accordingly, since it is possible to prevent unauthorized use such as spoofing by a malicious third person, it becomes possible to make dynamic service linkage while maintaining the confidence between linked servicers.

Moreover, the mediation computer 3 may transmit the received certification information to a service request computer 1 of a user who requested reception of said one service. When the certification information is transmitted to the service request computer 1, the user can confirm the fact that the servicer certificated that reception of said one service from the servicer was requested. Accordingly, since it is possible to prevent a user from receiving linkage service which cannot be originally provided to him as an unauthorized user without intending to, it becomes possible to provide a more reliable servicer linkage system.

An embodiment for preliminarily generating a linkage service list was described in the above Embodiment. The present invention is, however, not limited to such an embodiment and may be an embodiment for generating a linkage service list upon acceptance of a service provision request from a service request computer as a trigger.

Moreover, an embodiment for providing service was described in the above Embodiment. The present invention is, however, not limited to such an embodiment and may be applied to a variety of embodiments such as an embodiment for trading a commercial product instead of a service or an embodiment for providing both of service and a commercial product.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A servicer linkage method, in which a plurality of service providing computers for respectively holding information on service respectively provided by a plurality of servicers, a service request computer for accepting selection of service and requesting service, and a mediation computer capable of transmitting and receiving data to and from said plurality of service providing computers and said service request computer via a communication network are used, when said service request computer requests one service, capable of requesting reception of another service linked with said one service, comprising steps of
accepting, by said mediation computer, service linkage request condition information, which indicates a service linkage condition and requests service linkage, from a first service providing computer included in said plurality of service providing computers;
accepting, by said mediation computer, service linkage permission condition information, which indicates a condition for permitting service linkage, from a second service providing computer included in said plurality of service providing computers; and
generating, by said mediation computer, a linkage service list, which shows a combination of services that can be linked, on the basis of said service linkage request condition information accepted from said first service providing computer and said service linkage permission condition information accepted from said second service providing computer.

2. A servicer linkage system, which includes: a plurality of service providing computers for respectively holding information on service respectively provided by a plurality of servicers; a service request computer for accepting selection of service and requesting service; and a mediation computer capable of transmitting and receiving data to and from said plurality of service providing computers and said service request computer via a communication network; and which, when said service request computer requests one service, can request reception of another service linked with said one service, wherein
said mediation computer comprises:
means for accepting service linkage request condition information, which indicates a service linkage condition and requests service linkage, from a first service providing computer included in said plurality of service providing computers;
means for accepting service linkage permission condition information, which indicates a condition for permitting service linkage, from a second service providing computer included in said plurality of service providing computers; and
linkage service list generating means for generating a linkage service list, which shows a combination of services that can be linked, on the basis of said service linkage request condition information accepted from said first service providing computer and said service linkage permission condition information accepted from said second service providing computer.

3. The servicer linkage system as set forth in claim 2, wherein said mediation computer further comprises:
storage means for storing a service list which shows service respectively provided by said plurality of service providing computers;
first service extracting means for extracting a service, which meets a linkage partner condition indicated by said service linkage request condition information accepted from said first service providing computer, from said service list as a first service; and
second service extracting means for extracting a service, which meets a condition for permitting linkage indicated by said service linkage permission condition information accepted from said second service providing computer, from said service list as a second service;
wherein said linkage service list generating means generates said linkage service list on the basis of meeting status between a service provided by said first service providing computer and said second service and meeting status between a service provided by said second service providing computer and said first service.

4. The servicer linkage system as set forth in claim 3, wherein said mediation computer further comprises:
service identifying information accepting means for accepting service identifying information, which identifies a service selected by said service request computer, from said service request computer;
linkage service extracting means for extracting a service, which can be linked with said service identified by said service identifying information accepted by said service identifying information accepting means, from said linkage service list; and
means for linking said service identified by said service identifying information accepted from said service request computer and said service extracted from said service list.

5. The servicer linkage system as set forth in claim 4, wherein
said mediation computer further comprises means for transmitting information, which indicates acceptance of a provision request of one service from said service request computer, to a service providing computer, which provides said one service, included in said plurality of service providing computers;
said plurality of service providing computers respectively comprise means for generating certification information, which certificates provision of said one service, and transmitting said certification information to said mediation computer when receiving information, which indicates acceptance of said provision request of said one service from said service request computer, from said mediation computer; and
said mediation computer receives said certification information from a service providing computer which transmitted said certification information and transmits said received certification information to a service providing computer which provides said another service.

6. A servicer linkage system, which includes: a plurality of service providing computers for respectively holding information on service respectively provided by a plurality of servicers; a service request computer for accepting selection of service and requesting service; and a mediation computer capable of transmitting and receiving data to and from said plurality of service providing computers and said service request computer via a communication network; and which, when said service request computer requests one service, can request reception of another service linked with said one service, wherein
said mediation computer comprises a controller, coupled to a memory device, and capable of performing the following operations of
accepting service linkage request condition information, which indicates a service linkage condition and requests service linkage, from a first service providing computer included in said plurality of service providing computers;
accepting service linkage permission condition information, which indicates a condition for permitting service linkage, from a second service providing computer included in said plurality of service providing computers; and
generating a linkage service list, which shows a combination of services that can be linked, on the basis of said service linkage request condition information accepted from said first service providing computer and said service linkage permission condition information accepted from said second service providing computer.

7. The servicer linkage system as set forth in claim 6, wherein said controller of said mediation computer further capable of performing the following operations of causing said memory device to store a service list which shows service respectively provided by said plurality of service providing computers;
extracting a service, which meets a linkage partner condition indicated by said service linkage request condition information accepted from said first service providing computer, from said service list as a first service;
extracting a service, which meets a condition for permitting linkage indicated by said service linkage permission condition information accepted from said second service providing computer, from said service list as a second service; and
generating said linkage service list on the basis of meeting status between a service provided by said first service providing computer and said second service and meeting status between a service provided by said second service providing computer and said first service.

8. The servicer linkage system as set forth in claim 7, wherein said controller of said mediation computer further capable of performing the following operations of
accepting service identifying information, which identifies a service selected by said service request computer, from said service request computer;
extracting a service, which can be linked with said service identified by said accepted service identifying information, from said linkage service list; and
linking said service identified by said service identifying information accepted from said service request computer and said service extracted from said service list.

9. The servicer linkage system as set forth in claim 8, wherein said controller of said mediation computer further capable of performing the following operation of transmitting information, which indicates acceptance of a provision request of one service from said service request computer, to a service providing computer, which provides said one service, included in said plurality of service providing computers;
said plurality of service providing computers respectively comprise a controller capable of performing the following operation of generating certification information, which certificates provision of said one service, and transmitting said certification information to said mediation computer when receiving information, which indicates acceptance of said provision request of said one service from said service request computer, from said mediation computer; and
said controller of said mediation computer further capable of performing the following operation of receiving said certification information from a service providing computer which transmitted said certification information and transmitting said received certification information to a service providing computer which provides said another service.

10. A mediation computer, which can transmit and receive data to and from a plurality of service providing computers that provide service and a service request computer that selects service to be provided and receives provision via a communication network and links one service with another service provided by said service providing computers, comprising:
means for accepting service linkage request condition information, which indicates a service linkage condition and requests service linkage, from a first service providing computer included in said plurality of service providing computers;
means for accepting service linkage permission condition information, which indicates a condition for permitting service linkage, from a second service providing computer included in said plurality of service providing computers; and
means for generating a linkage service list, which shows a combination of services that can be linked, on the basis of said service linkage request condition information accepted from said first service providing computer and said service linkage permission condition information accepted from said second service providing computer.

11. A computer program product for controlling a computer, which can transmit and receive data to and from a plurality of service providing computers that provide service and a service request computer that selects service to be provided and receives provision via a communication network, and can links one service with another service provided by said service providing computers, wherein said computer program product comprises:
a computer readable storage medium having computer readable program code means embodied in said medium, said computer readable program code means comprising computer instruction means for:
accepting service linkage request condition information, which indicates a service linkage condition and requests service linkage, from a first service providing computer;
accepting service linkage permission condition information, which indicates a condition for permitting service linkage, from a second service providing computer; and
generating a linkage service list, which shows a combination of services that can be linked, on the basis of said service linkage request condition information and said service linkage permission condition information.
